(19) United States
(12) Patent Application Publication
(10) Pub. No.: US 2025/0098627 A1
(43) Pub. Date: Mar. 27, 2025

(54) Car Seat Pet Pad Device

(71) Applicant: Richard Hays, Camden, SC (US)

(72) Inventor: Richard Hays, Camden, SC (US)

(21) Appl. No.: 18/888,790

(22) Filed: Sep. 18, 2024

Related U.S. Application Data
(60) Provisional application No. 63/585,610, filed on Sep. 27, 2023.

(51) Int. Cl. A01K 1/01; B60N 2/60

(52) U.S. Cl. CPC A01K 1/0107; B60N 2/60

(57) ABSTRACT

A car seat pet pad device is disclosed, which is an absorbent pee pad for a car seat. The car seat pet pad device comprises an absorbent component that is configured in a square or rectangular shape to fit a base of a car seat. The absorbent component comprises a tab that is tucked into the car seat to hold the device in place. The absorbent component also includes an elastic band that secures around a perimeter of the car seat base. The absorbent component is comprised of multiple layers to offer leak-proof protection. Further, the absorbent component includes a plastic backing to protect against splashes. Finally, the device is disposable and provides easy clean up, as needed.

### CROSS-REFERENCE TO RELATED APPLICATION

The present application claims priority to, and the benefit of, U.S. Provisional Application No. 63/585,610, which was filed on Sep. 27, 2023, and is incorporated herein by reference in its entirety.

### FIELD OF THE INVENTION

The present invention relates generally to the field of car seat pet pad devices. More specifically, the present invention relates to a device that protects a car seat from pet urination and defecation. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in car seat pet pad devices. Generally, many individuals allow their dogs to sit in a car seat while traveling. Some dogs may have accidents and defecate or urinate on a car seat. This in undesirable, as the seat must then be cleaned.

Even well-trained dogs can have an accident when traveling, requiring lots of work to clean, and potentially causing damage to a car's interior upholstery. Further, a means for keeping messes from leaking onto seats is required. Prior art seat pads can shift around distractingly when the car is in motion, or they use damaging adhesives that can ruin seat surfaces. A need exists for a device that protects seats and provides for fast and easy cleanup if messes occur.

Accordingly, there is a demand for an improved car seat pet pad device that protects a car seat from pet urination and defecation. More particularly, there is a demand for a car seat pet pad device that can be secured to a car seat via a tab and elastic perimeter, without the need for damaging adhesives.

Therefore, there exists a long felt need in the art for a car seat pet pad device that provides users with a device that protects a car seat from pet urination and defecation. There is also a long felt need in the art for a car seat pet pad device that is an absorbent pee pad for a car seat. Further, there is a long felt need in the art for a car seat pet pad device that is secured to a car seat via a tab that is tucked into the seat. Moreover, there is a long felt need in the art for a device that comprises an elastic perimeter which surrounds the car seat. Further, there is a long felt need in the art for a car seat pet pad device that includes a waterproof plastic backing to protect against splashes and leaks. Finally, there is a long felt need in the art for a car seat pet pad device that is disposable.

The subject matter disclosed and claimed herein, in one embodiment thereof, comprises a car seat pet pad device. The device is an absorbent pee pad for a car seat. The car seat pet pad device comprises an absorbent component that is configured in a square or rectangular shape to fit a base of a car seat. The absorbent component comprises a tab that is tucked into the car seat to hold the device in place. The absorbent component also includes an elastic band that secures around a perimeter of the car seat base. The absorbent component is comprised of multiple layers to offer leak-proof protection. Further, the absorbent component includes a splash guard to protect against splashes. Finally, the device is disposable and provides easy clean up, as needed.

In this manner, the car seat pet pad device of the present invention accomplishes all of the forgoing objectives and provides users with a device that protects car seats from accidents. The device is an absorbent pad that contains leaks and prevents messes. The device is disposable after use.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a car seat pet pad device. The device is an absorbent pee pad for a car seat. The car seat pet pad device comprises an absorbent component that is configured to fit over a base of a car seat. The absorbent component is secured via a tab that is tucked into the car seat and an elastic band that secures around a perimeter of the car seat base. The absorbent component is comprised of multiple layers to offer leak-proof protection. Finally, the device is disposable and provides easy clean up, as needed.

In one embodiment, the car seat pet pad device is a fitted disposable pet pee pad designed to protect vehicle seats from pet messes. Even a well-trained pet can have an accident when traveling, requiring lots of work to clean, and potentially causing damage to a vehicle's interior upholstery. The car seat pet pad device securely fits around car seats, offering protection from pee and other messes, keeping liquids from leaking onto seats. Further, most prior art pads contain damaging adhesives that can ruin a seat surface or shift around distractingly when the vehicle is in motion. Accordingly, the car seat pet pad device provides several protective layers that fit securely around a vehicle car seat and offer fast and easy cleanup.

In one embodiment, the car seat pet pad device comprises an absorbent component. The absorbent component is configured in a square or rectangular shape to fit a base of a car seat. However, the absorbent component can be configured in any suitable size and shape as is known in the art, as long as it is sized and shaped to completely cover a base or seat portion of a vehicle car seat for pets.

In one embodiment, the absorbent component comprises a tab that is tucked into the car seat to hold the device in place. Specifically, the rear of the absorbent component comprises an extension of material which forms the tab. The tab is typically rectangular in shape but can be any suitable shape as is known in the art. Further, the tab is configured to tuck between the seat cushions of the car seat, to hold the absorbent component securely in place on the seat.

In one embodiment, the absorbent component also includes an elastic band that secures around a perimeter of the car seat base. The elastic band secures around the entire absorbent component perimeter to hold the absorbent component securely in place on the seat. Thus, the elastic band keeps the absorbent component snug to the seat without the need for damaging adhesives. Further, the elastic band extends the absorbent component down to completely cover the entirety of the sides of the car seat base, creating an elastic skirting. Typically, the elastic skirting tapers upward toward a back edge of the car seat base, to allow for seatbelt access.

In one embodiment, the absorbent component comprises a waterproof plastic backing layer. Typically, the waterproof plastic backing layer is a leak-proof Polyethylene (PE) layer. This layer prevents liquids from contacting the car seat base.

In one embodiment, the absorbent component is comprised of multiple layers to offer leak-proof protection. Specifically, the absorbent component comprises a tear resistant quilted, perforated film top layer. This top layer can include multiple designs and decorations, such as puppy paws, shapes, etc. The layers underneath the top layer include a quick dry tissue layer, a super absorbent polymer (SAP), odor-capturing charcoal layer, and a liquid locking tissue layer. These layers are then secured to the waterproof plastic backing layer. The multiple layers offer better protection and prevent the absorbent component from tearing during use.

In one embodiment, the absorbent component includes a splash guard to protect against splashes. The splash guard is positioned at the back of the seat, in front of the tab. As the tab is tucked between the seat cushions, the splash guard extends upward, protecting the back of the car seat and preventing liquids from splashing up on the car seat. The splash guard can be any suitable size and shape as is known in the art as long as it protects the seat back during use of the device.

In one embodiment, the device is disposable and provides easy clean up, as needed. Once an accident occurs, the multiple layers hold in liquids and odors until the absorbent component can be disposed of and replaced. Thus, cleanup is quick and easy as a user merely gathers the used car seat pad device up and disposes of it, then a new car seat pet pad device can be positioned over the car seat and secured. Accordingly, the car seat pet pad device can be sold in packs of multiple pads.

In yet another embodiment, the car seat pet pad device comprises a plurality of indicia.

In yet another embodiment, a method of protecting a car seat from pet accidents is disclosed. The method includes the steps of providing a car seat pet pad device comprising an absorbent component with an elastic perimeter. The method also comprises securing the absorbent component to a car seat base via the elastic perimeter. Further, the method comprises positioning the splash guard to protect the seat back. The method also comprises inserting the tab between the car seat cushions to secure the device in place. Finally, the method comprises removing the device after an accident and disposing of the device in the trash.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the car seat pet pad device of the present invention in accordance with the disclosed architecture;

FIG. 2 illustrates a perspective view of one embodiment of the car seat pet pad device of the present invention showing the elastic perimeter in accordance with the disclosed architecture;

FIG. 3 illustrates a perspective view of one embodiment of the car seat pet pad device of the present invention showing the multiple layers of the absorbent component in accordance with the disclosed architecture;

FIGS. 4A-D illustrate a perspective view of one embodiment of the car seat pet pad device of the present invention showing the device in use in accordance with the disclosed architecture;

FIGS. 5A-C illustrate a perspective view of one embodiment of the car seat pet pad device of the present invention showing the components of the device in accordance with the disclosed architecture; and

FIG. 6 illustrates a flowchart showing the method of protecting a car seat from pet accidents in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a car seat pet pad device that provides users with a device that protects a car seat from pet urination and defecation. There is also a long felt need in the art for a car seat pet pad device that is an absorbent pec pad for a car seat. Further, there is a long felt need in the art for a car seat pet pad device that is secured to a car seat via a tab that is tucked into the seat. Moreover, there is a long felt need in the art for a device that comprises an elastic perimeter which surrounds the car seat. Further, there is a long felt need in the art for a car seat pet pad device that includes a waterproof plastic backing to protect against splashes and leaks. Finally, there is a long felt need in the art for a car seat pet pad device that is disposable.

The present invention, in one exemplary embodiment, is a novel car seat pet pad device. The car seat pet pad device comprises an absorbent component that is configured in a square or rectangular shape to fit a base of a car seat. The absorbent component comprises a tab that is tucked into the car seat to hold the device in place. The absorbent component also includes an elastic band that secures around a perimeter of the car seat base. The absorbent component is comprised of multiple layers to offer leak-proof protection. Further, the absorbent component includes a splash guard to protect against splashes. Finally, the device is disposable and provides easy clean up, as needed. The present invention also includes a novel method of protecting a car seat from pet accidents. The method includes the steps of providing a car seat pet pad device comprising an absorbent component with an elastic perimeter. The method also comprises securing the absorbent component to a car seat base via the elastic perimeter. Further, the method comprises positioning the splash guard to protect the seat back. The method also comprises inserting the tab between the car seat cushions to secure the device in place. Finally, the method comprises removing the device after an accident and disposing of the device in the trash.

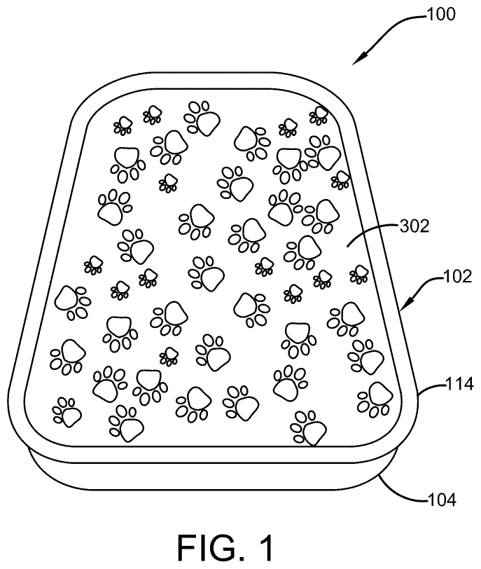

Referring initially to the drawings, FIG. 1 illustrates a perspective view of one embodiment of the car seat pet pad device 100 of the present invention. In the present embodiment, the car seat pet pad device 100 is an improved car seat pet pad device 100 that provides a user with an absorbent pee pad for a car seat 108. Specifically, the car seat pet pad device 100 comprises an absorbent component 102 with an elastic perimeter 104 that is configured to fit over a base 106 of a car seat 108. The absorbent component 102 is comprised of multiple layers to offer leak-proof protection. Finally, the device 100 is disposable and provides easy clean up, as needed.

Generally, the car seat pet pad device 100 is a fitted disposable pet pee pad designed to protect vehicle seats 108 from pet messes. Even a well-trained pet 110 can have an accident when traveling, requiring lots of work to clean, and potentially causing damage to a vehicle's interior upholstery. The car seat pet pad device 100 securely fits around car seats 108, offering protection from pee and other messes, keeping liquids from leaking onto seats 108. Further, most prior art pads contain damaging adhesives that can ruin a seat surface or shift around distractingly when the vehicle is in motion. Accordingly, the car seat pet pad device 100 provides several protective layers that fit securely around a vehicle car seat 108 and offer fast and easy cleanup.

Further, the car seat pet pad device 100 comprises an absorbent component 102. The absorbent component 102 is configured in a square or rectangular shape to fit a base 106 of a car seat 108. However, the absorbent component 102 can be configured in any suitable size and shape as is known in the art, as long as it is sized and shaped to completely cover a base 106 or seat portion of a vehicle car seat 108. Thus, the absorbent component 102 typically mirrors the size and shape of the vehicle car seat 108 that needs protection from liquids and accidents.

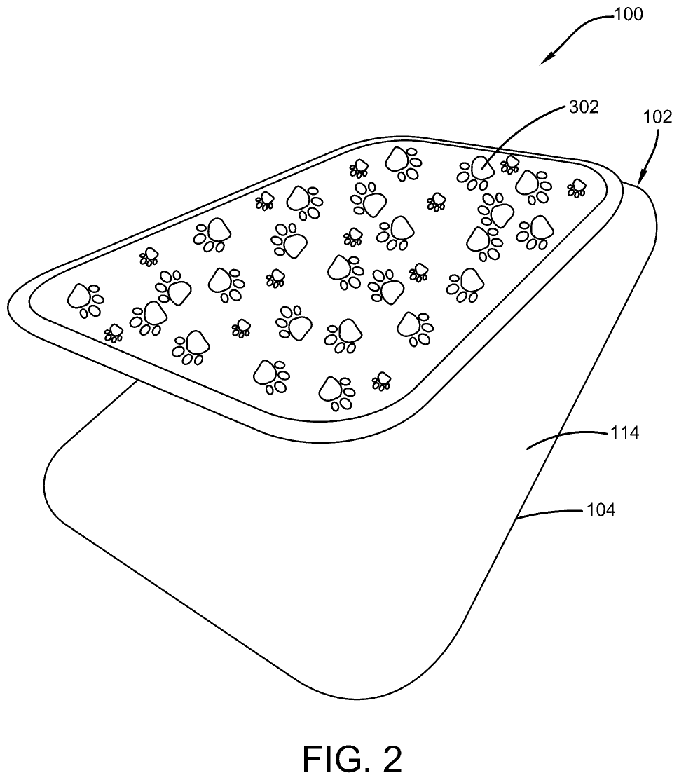

As shown in FIG. 2, the absorbent component 102 also includes an elastic band 104 that secures around a perimeter of the car seat base 106. The elastic band 104 secures around the entire absorbent component 102 perimeter to hold the absorbent component 102 securely in place on the seat 108. Thus, the elastic band 104 keeps the absorbent component 102 snug to the seat 108 without the need for damaging adhesives. The elastic band 104 also allows for easy removal and disposable after a pet accident. Further, the elastic band 104 extends the absorbent component 102 down to completely cover the entirety of the sides 112 of the car seat base 106, creating an elastic skirting 114. Typically, the elastic skirting 114 tapers upward toward a back edge 116 of the car seat base 106, to allow for seatbelt access.

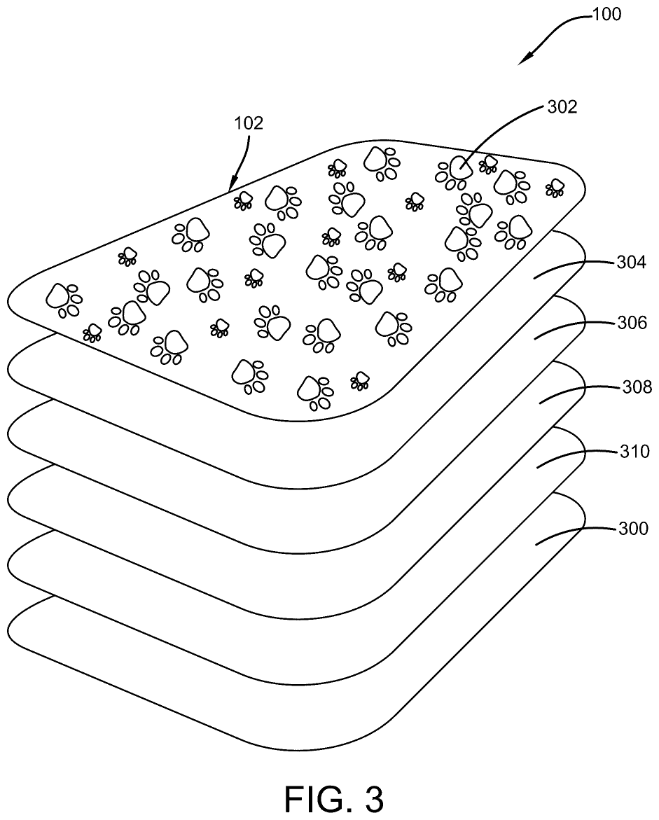

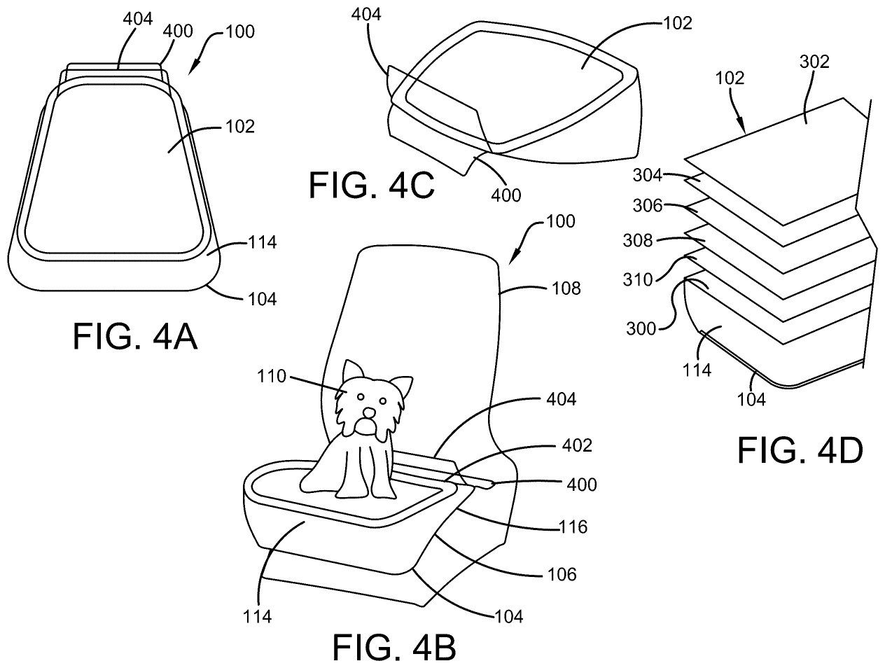

As shown in FIGS. 3 and 4A-C, the absorbent component 102 comprises a waterproof plastic backing layer 300. Typically, the waterproof plastic backing layer 300 is a leak-proof Polyethylene (PE) layer. This layer 300 prevents liquids from contacting the car seat base 106.

Further, the absorbent component 102 is comprised of multiple layers to offer leak-proof protection. Specifically, the absorbent component 102 comprises a tear resistant quilted, perforated film top layer 302. This top layer 302 can include multiple designs and decorations, such as puppy paws, shapes, etc. The layers underneath the top layer 302 include a quick dry tissue layer 304, a super absorbent polymer (SAP) 306, odor-capturing charcoal layer 308, and a liquid locking tissue layer 310. These layers are then secured to the waterproof plastic backing layer 300. The multiple layers offer better protection and prevent the absorbent component 102 from tearing during use.

Additionally, the absorbent component 102 comprises a tab 400 that is tucked into the car seat 108 to hold the device 100 in place. Specifically, the rear 402 of the absorbent component 102 comprises an extension of material which forms the tab 400. The tab 400 is typically rectangular in shape but can be any suitable shape as is known in the art. Further, the tab 400 is configured to tuck between the seat cushions of the car seat 108, to hold the absorbent component 102 securely in place on the seat 108.

Furthermore, the absorbent component 102 includes a splash guard 404 to protect against splashes. The splash guard 404 is positioned at the back of the seat, in front of the tab 400. As the tab 400 is tucked between the seat cushions, the splash guard 404 extends upward, protecting the back of the car seat 108 and preventing liquids from splashing up on the car seat 108. The splash guard 404 can be any suitable size and shape as is known in the art as long as it protects the seat back during use of the device 100.

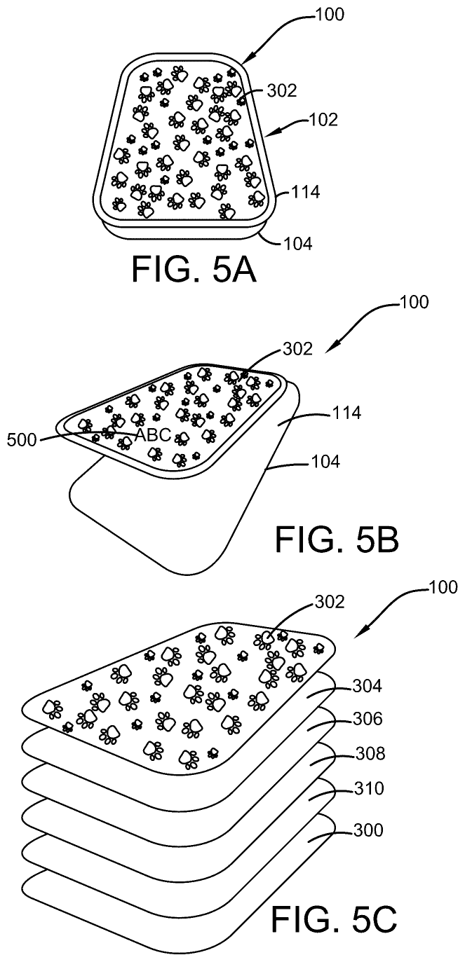

As shown in FIGS. 5A-C, the device 100 is disposable and provides easy clean up, as needed. Once an accident occurs, the multiple layers hold in liquids and odors until the absorbent component 102 can be disposed of and replaced. Thus, cleanup is quick and easy as a user merely gathers the used car seat pad device 100 up and disposes of it, then a new car seat pet pad device 100 can be positioned over the car seat 108 and secured. Accordingly, the car seat pet pad device 100 can be sold in packs of multiple pads.

In yet another embodiment, the car seat pet pad device 100 comprises a plurality of indicia 500. The absorbent component 102 of the device 100 may include advertising, a trademark, or other letters, designs, or characters, printed, painted, stamped, or integrated into the absorbent component 102, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be pet, car seat, or brand related.

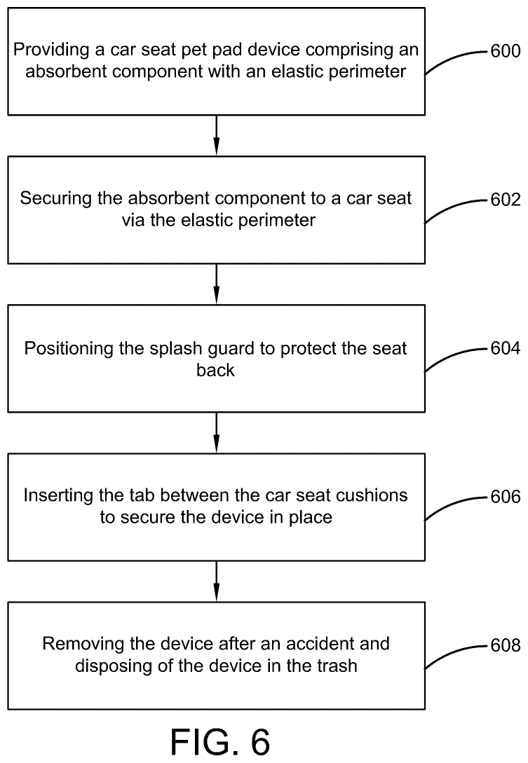

FIG. 6 illustrates a flowchart of the method of protecting a car seat from pet accidents. The method includes the steps of at 600, providing a car seat pet pad device comprising an absorbent component with an elastic perimeter. The method also comprises at 602, securing the absorbent component to a car seat base via the elastic perimeter. Further, the method comprises at 604, positioning the splash guard to protect the seat back. The method also comprises at 606, inserting the tab between the car seat cushions to secure the device in place. Finally, the method comprises at 608, removing the device after an accident and disposing of the device in the trash.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “car seat pet pad device”, “car seat device”, “pet pad device”, and “device” are interchangeable and refer to the car seat pet pad device 100 of the present invention.

Notwithstanding the forgoing, the car seat pet pad device 100 of the present invention can be of any suitable size and configuration as is known in the art without affecting the overall concept of the invention, provided that it accomplishes the above stated objectives. One of ordinary skill in the art will appreciate that the car seat pet pad device 100 as shown in FIGS. 1-6 is for illustrative purposes only, and that many other sizes and shapes of the car seat pet pad device 100 are well within the scope of the present disclosure. Although the dimensions of the car seat pet pad device 100 are important design parameters for user convenience, the car seat pet pad device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

what is claimed is:

1. A car seat pet pad device that provides a user with an absorbent pee pad for a car seat, the car seat pet pad device comprising:
an absorbent component;
wherein the absorbent component is positioned over a car seat; and
further wherein the absorbent component is comprised of multiple layers of leak-proof protection for a car seat to protect against accidents.

2. The car seat pet pad device of claim 1, wherein the absorbent component is configured to fit over a base of a car seat to completely cover it.

3. The car seat pet pad device of claim 2, wherein the absorbent component also includes an elastic band that secures around a perimeter of the car seat base.

4. The car seat pet pad device of claim 3, wherein the elastic band secures around an entire absorbent component perimeter to hold the absorbent component securely in place on the car seat base.

5. The car seat pet pad device of claim 4, wherein the elastic band extends the absorbent component down to completely cover an entirety of sides of the car seat base, creating an elastic skirting.

6. The car seat pet pad device of claim 5, wherein the elastic skirting tapers upward toward a back edge of the car seat base, to allow for seatbelt access.

7. The car seat pet pad device of claim 6, wherein the absorbent component comprises a waterproof plastic backing layer that prevents liquids from contacting the car seat base.

8. The car seat pet pad device of claim 7, wherein the waterproof plastic backing layer is a leak-proof Polyethylene (PE) layer.

9. The car seat pet pad device of claim 8, wherein the absorbent component is comprised of multiple layers on top of the waterproof plastic backing layer.

10. The car seat pet pad device of claim 9, wherein a top layer is a tear resistant quilted top layer.

11. The car seat pet pad device of claim 10, wherein layers underneath the top layer include a quick dry tissue layer, a super absorbent polymer (SAP), an odor-capturing charcoal layer, and a liquid locking tissue layer.

12. The car seat pet pad device of claim 11, wherein the multiple layers and the top layer are then secured to the waterproof plastic backing layer to offer better protection and prevent the absorbent component from tearing during use.

13. The car seat pet pad device of claim 12, wherein the absorbent component comprises a tab that is tucked into the car seat to hold the absorbent component in place during use.

14. The car seat pet pad device of claim 13, wherein the absorbent component includes a splash guard to protect against splashes and is positioned at a rear of the car seat.

15. A car seat pet pad device that provides a user with an absorbent pee pad for a car seat, the car seat pet pad device comprising:
an absorbent component configured to fit over a base of a car seat to completely cover it;
wherein the absorbent component also includes an elastic band that secures around a perimeter of the car seat base;
wherein the elastic band extends the absorbent component down to completely cover an entirety of sides of the car seat base, creating an elastic skirting;
wherein the elastic skirting tapers upward toward a back edge of the car seat base, to allow for seatbelt access;
wherein the absorbent component comprises a waterproof plastic backing layer that prevents liquids from contacting the car seat base;
wherein a top layer is a tear resistant quilted top layer;
wherein layers underneath the top layer include a quick dry tissue layer, a super absorbent polymer (SAP), an odor-capturing charcoal layer, and a liquid locking tissue layer;
wherein the layers and the top layer are then secured to the waterproof plastic backing layer to offer better protection and prevent the absorbent component from tearing during use;
wherein the absorbent component comprises a tab that is tucked into the car seat to hold the absorbent component in place during use;
wherein the absorbent component includes a splash guard to protect against splashes and is positioned at a rear of the car seat; and
further wherein the absorbent component protects the car seat against pet accidents.

16. The car seat pet pad device of claim 15, wherein the absorbent component is disposable.

17. The car seat pet pad device of claim 15, wherein the top layer includes multiple designs and decorations, such as puppy paws and shapes.

18. The car seat pet pad device of claim 15, wherein the tab is configured to tuck between seat cushions of the car seat, to hold the absorbent component securely in place on the car seat.

19. The car seat pet pad device of claim 15 further comprising a plurality of indicia.

20. A method of protecting a car seat from pet accidents, the method comprising the following steps:
providing a car seat pet pad device comprising an absorbent component with an elastic perimeter;
securing the absorbent component to a car seat base via the elastic perimeter;
positioning the splash guard to protect the seat back;
inserting the tab between the car seat cushions to secure the device in place; and
removing the device after an accident and disposing of the device in the trash.
